(19) United States
(12) Patent Application Publication
(10) Pub. No.: US 2009/0217643 A1
(43) Pub. Date: Sep. 3, 2009

(54) Gas discharge device for a vehicle engine

(76) Inventors: Jagdish S. Sokhey, Indianapolis, IN (US); Kenneth W. Froemming, Carmel, IN (US); Steve Bergeron, Indianapolis, IN (US); Scott Matthews, Greenwood, IN (US)

Correspondence Address: KRIEG DEVAULT LLP, ONE INDIANA SQUARE, SUITE 2800, INDIANAPOLIS, IN, 46204-2079, US

(21) Appl. No.: 12/074,025

(22) Filed: Feb. 29, 2008

(51) Int. Cl. F02K 3/02

(52) U.S. Cl. 60/262

(57) ABSTRACT

The present invention provides gas discharge technique useful on vehicle engines. The technique comprises an s-shaped duct having an ejector formed therein to mix hot exhaust gas with a relatively cooler airflow entrained by the ejector. The s-shaped duct may be comprised of a number of segments that when integrated form the s-shape and ejector. A variety of cross sections including circular and rectangular are provided for the s-shaped duct. The segments may be composed of smaller subsections and may further have cooling slots. A nacelle is provided to at least partially enclose the s-shaped conduit and may have an inlet that is in fluid communication with the ejector of the s-shaped conduit.

### BACKGROUND

The present invention relates generally to gas discharge techniques for vehicle engines, and more particularly, but not exclusively, to signature suppression for gas turbine engines of airborne vehicles.

Signature suppression remains an area of significant interest for both homeland security and military purposes. Unfortunately, some existing systems have various shortcomings relative to certain applications. Accordingly, there remains a need for further contributions in this area of technology.

### SUMMARY

One embodiment of the present application is a unique discharge technique for a vehicle engine. Other embodiments include unique apparatus, systems, devices, hardware, methods, and combinations for signature suppression. Further embodiments, forms, objects, features, advantages, aspects, and benefits of the present invention shall become apparent from the following description and drawings.

### BRIEF DESCRIPTION OF THE DRAWINGS

FIG. 1 is a partial schematic side view of a turboprop powered aircraft having a suppression device including an ejector.

FIG. 2 is a side view of an s-shaped conduit in another type of a suppression device shown from the side opposite that depicted in FIG. 1 that may be used in place of the suppression device of FIG. 1.

FIG. 3 is a diagrammatic end view of an exhaust segment of the suppression device taken along the 3-3 view line of FIG. 2.

FIG. 4 is a diagrammatic end view of an exhaust segment opposite the end view of FIG. 3 as taken along the 4-4 view line of FIG. 2.

FIG. 5 is a side view of yet another type of suppression device with an s-shaped conduit that can be used in place of the suppression device of FIG. 1.

FIG. 6 is a partially diagrammatic, cut away side view of an s-shaped conduit of still another type of suppression device that can be used in place of the suppression device of FIG. 1.

### DETAILED DESCRIPTION OF REPRESENTATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the illustrated device, and any further applications of the principles of the invention as illustrated therein being contemplated as would normally occur to one skilled in the art to which the invention relates.

One embodiment of the present application is a gas turbine engine that includes an s-shaped conduit having an ejector formed therein. The s-shaped conduit is configured downstream of the outlet of the gas turbine engine and serves to radially displace an exhaust flow generated by the engine to alter the line of sight angles from which infrared radiation may be detected. The ejector additionally serves to reduce total emitted infrared radiation by entraining non-exhaust flow air into the exhaust flow to create a cooled flow mixture. The ejector may be located at a point upstream of an inflection point in the s-shaped conduit. As used herein, the term “inflection point” means a point where a tangent line to such point reverses direction. A nacelle may be attached near the gas turbine engine to house the s-shaped conduit and may have an inlet that is in fluid communication with the ejector.

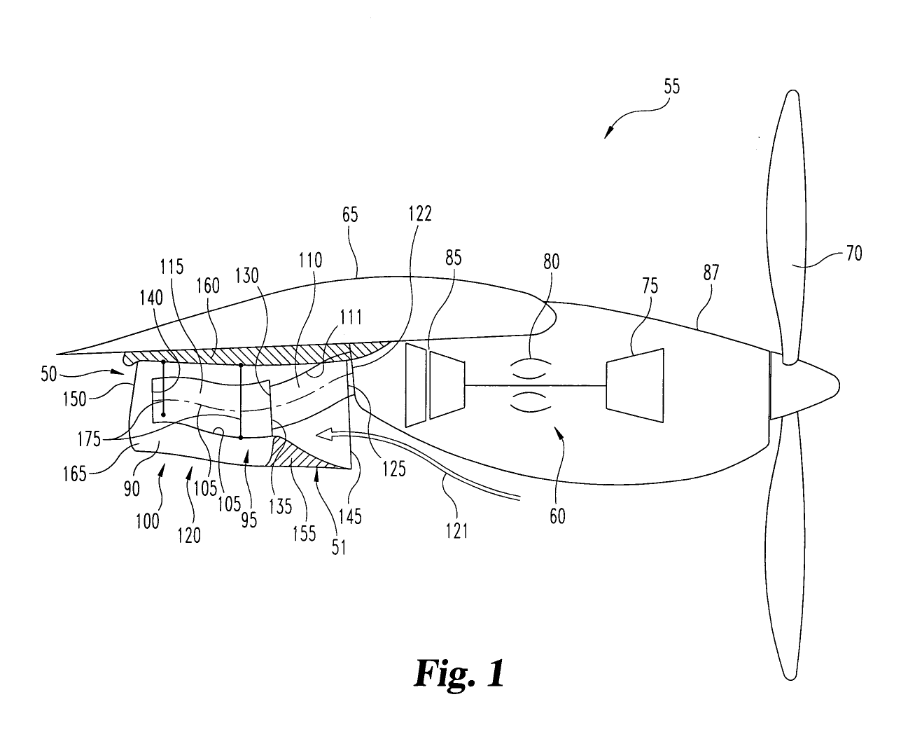

For another embodiment, FIG. 1 illustrates a turboprop aircraft 55 having a nozzle system 50 including a suppression device 51. The nozzle system 50 is installed on the aircraft 55 which includes a gas turbine engine 60 located beneath and somewhat fore of a wing 65 of the aircraft 55; however, in other embodiments the position of the nozzle system 50 to the wing, aircraft, or other application may differ. The aircraft 55 further includes the gas turbine engine 60 that provides power to turn the propeller 70 and comprises at least one compressor 75, combustor 80, and two turbines 85 in a free turbine arrangement; however, it should be appreciated that other forms may include more or fewer gas turbine engine components with correspondingly different arrangements. A cowling 87 encloses the gas turbine engine 60 to create an aerodynamic fairing for reduced drag. In the depicted embodiments, the gas turbine engine 60 is of a turboprop type, and the aircraft 55 is of a fixed wing type. Nonetheless, in other embodiments a different engine and/or aircraft type may be utilized; where the term aircraft includes, but is not limited to, helicopters, airplanes, unmanned space vehicles, fixed wing vehicles, variable wing vehicles, rotary wing vehicles, hover crafts, and others. Further, in various embodiments of the present application, other applications are contemplated that may not include an aircraft such as, for example, industrial applications, power generation, pumping sets, naval propulsion and other applications known to one of ordinary skill in the art.

In this nonlimiting example, the nozzle system 50 is shown located beneath the wing 65 of the aircraft 55 downstream of the gas turbine engine 60. The nozzle system 50 includes an s-shaped discharge duct 90 (alternatively designated an s-shaped conduit 95) as well as a nacelle 100. The system 50 is structured to suppress the infrared (IR) signature that would otherwise result from the discharge of hot exhaust therethrough. In operation, hot exhaust from the gas turbine engine 60 is routed through the s-shaped duct 90 and out the downstream end of the nacelle 100. The s-shaped character of the s-shaped duct 90 forces the exhaust flow to be radially displaced while still preserving the axial direction of the exhaust flow that existed prior to entering the s-shaped duct 90. However, in other forms, the axial flow direction may not be entirely or substantially preserved. The s-shaped duct 90 has a sinuous shape 105, the nature of which is described further hereinbelow.

The S-shaped duct 90 includes a first segment 110 and a second segment 115 and further includes an ejector 120 formed by the relative orientation between the first segment 110 and the second segment 115. The s-shaped duct 90 is shaped to reduce, if not eliminate any line of sight to the turbines 85 by an external observer looking through the discharge end thereof; thus reducing the detectable emitted infrared radiation from gas turbine engine 60. In addition, external air, as represented by the arrow designated with reference numeral 121, is provided to the s-shaped duct 90 through the action of the ejector 120 and thereafter mixed with hot exhaust flow. Mixing exhaust flow with external flow reduces the temperature of the flow traveling through the s-shaped duct 90 and therefore further reduces the signature of emitted radiation. As used herein, the terms “external flow” or “external air” means air flow that is external to the flow path through the gas turbine engine core, i.e. the air flow along a path through compressor 75, combustor 80 and turbines 85; that is typically cooler in temperature than the core flow. As an example, air flow downstream of the propeller 70 is one form of “external air.” In addition, air flow at ambient conditions upstream of the propeller 70 is also included in the meaning of such terms.

The first segment 110 of the s-shaped duct 90 is attached to an outlet 122 of the gas turbine engine 60 to receive hot exhaust flow. In one form, the first segment 110 is permanently attached to the gas turbine engine 60, but in other forms may be releasably attached. In yet other forms, the first segment 110 may be an integral part of the gas turbine engine 60. The first segment 110 defines a first segment inlet opening 125 and a first segment exit opening 130 in fluid communication with one another to via first segment passage 111 to provide a first segment flow path therethrough. As exhaust flow exits the gas turbine engine 60, it is substantially captured by the first segment 110 through the opening 125 so that it may be conveyed further downstream through the passage 111. As the exhaust flow is conveyed downstream through passage 111, it is radially displaced by the geometry of the first segment 110. In the illustrated embodiment, the first segment 110 only partially provides for the final radial displacement of exhaust flow downstream of the nozzle system 50, but in other embodiments the first segment 110 may be configured to provide all or none of the final radial displacement. In addition to radial displacement, in some implementations the first segment 110 may be oriented at an angle relative to the longitudinal axis of the gas turbine engine 60. The first segment opening 125 substantially conforms in shape to the outlet 122 and may provide for an efficient flow path transition from the gas turbine engine 60 to the first segment 110. The opening 125 can be approximately circular in shape, but other shapes are also contemplated. Although not depicted in the illustrated embodiment, the interface between the first segment 110 and the outlet 122 of gas turbine engine 60 may or may not have an additional seal to prevent the escape of hot exhaust flow.

The second segment 115 is positioned downstream of the first segment 110 and is configured to receive exhaust flow traveling out of an exit opening 130 from first segment 110. The second segment 115 defines a second segment inlet opening 135 and a second segment exit opening 140 in fluid communication with one another via second segment passage 115 to provide a second segment flow path therethrough. The inlet opening 135 of the second segment 115 can be larger in size but typically conforms in shape to the exit opening 130 of the first segment 110. In some forms, the inlet opening 135 may not conform in shape to the exit 130. The inlet opening 135 may be approximately circular in some forms, but other shapes are also contemplated. The second segment 115 provides for the final radial displacement of the exhaust flow from the gas turbine engine 60. In some forms, the second segment 115 may provide none or all of the radial displacement of the s-shaped duct 90. A vector angle in the exhaust flow aft of the second segment 115 may be provided in some implementations.

The ejector 120 is formed when the inlet opening 135 receives the exit opening 130. Although the second segment 115 is shown oriented symmetrically from top to bottom about the first segment 110, other forms contemplate offsets in the configuration. For example, the inlet opening 135 may be oriented such that its top edge is coincident with the top edge of the exit opening 130, thus leaving a large and asymmetric gap created between the bottom of the inlet opening 135 and exit opening 130. The ejector 120 is configured to entrain an external flow of air with the exhaust flow traversing through s-shaped duct and is sized to accommodate a broad range of mass flows both in the internal hot exhaust flow and the pumped external air.

The nacelle 100 includes a nacelle inlet 145 opposite a nacelle outlet 150, a nacelle flow director 155, and a nacelle connector 160. The nacelle 100 is configured to substantially enclose the conduit 95, but in some implementations nacelle 100 may only partially enclose it. An outer surface 165 of the nacelle 100 provides an aerodynamic fairing for the nozzle system 50 such that aerodynamic drag is reduced. The nacelle 100 is connected to the wing 65 by the nacelle connector 160 and may be permanently or releasably connected. The nacelle flow director 155 is configured to be in fluid communication with the nacelle inlet 145 and the ejector 120, and may be configured as a ramp or other suitable structure for directing airflow. In some implementations, the flow director 155 may not be included such as when a nacelle is not provided, to name one possibility. During operation of the nozzle system 50, the airflow that is channeled to the ejector 120 by the flow director 155 is thereafter entrained with exhaust flow traversing the conduit 95. Mixed exhaust flow and external air flow are discharged from the nacelle outlet 150. In some implementations, the nacelle outlet 150 may be coincident with the second segment exit opening 140 such as when the outer surface 165 of the nacelle 100 converges at the second segment exit opening 140. Correspondingly, the outlet 150 is not defined separately from the opening 140. In other implementations, the nacelle outlet 150 may be axially and/or radially displaced from the second segment exit 140.

The duct segment support 175 is used to connect at least part of the s-shaped duct 90 to the nacelle 100, and may be permanently or releasably connected to either or both the s-shaped duct 90 and the nacelle 100. In the illustrated embodiment, the duct segment support 175 is configured to support the second segment 115 and suspend it aft of the first segment 110. The second segment 115 is not supported by the first segment 110, but in other forms the second segment 115 may be supported solely by the first segment 110 or via a combination of the first segment 110 and the duct segment support 175.

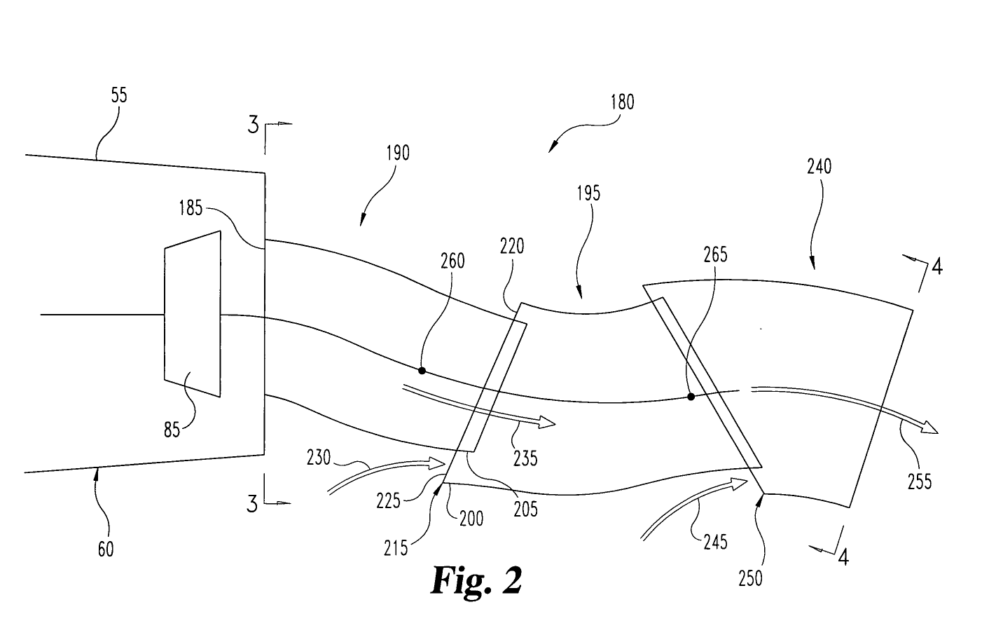

FIG. 2 depicts another embodiment of an ejector-assisted conduit for a suppression device including an s-shaped conduit 180; where like reference numerals refer to like features. The s-shaped conduit 180 is shown attached to the outlet 185 of the gas turbine engine 60 and comprises three segments. A first segment 190 may be attached to the outlet 185 of the turbine 85 as previously described in connection with the aircraft 55. A second segment 195 is located aft of the first segment 190 with a margin 200 of the second segment 195 receiving a margin 205 of the first segment 190. The spacing between the margin 200 and the margin 205 defines an axial overlap that is depicted as radially symmetric in FIG. 2, but it should be understood that any variety of configurations are contemplated, such as a larger overlap at the bottom of s-shaped conduit than at the top.

An ejector 215 is formed by the relative orientation of the second segment 195 and the first segment 190 and includes an ejector lip 220 that defines an inlet 225 of the ejector 215 in cooperation with the second segment 195. Airflow, as represented by the arrow designated by reference numeral 230, enters the inlet 225 at the bottom of the s-shaped conduit 180, but in other forms may also enter the ejector 215 substantially around the entire circumferential periphery of the s-shaped conduit 180. In other forms, the airflow 230 may enter at the top or sides of the ejector 215. In still other forms, the airflow 230 may be bifurcated into two streams or further divided into multiple streams before entering the ejector 215. The airflow 230 entering the ejector 215 is entrained in the exhaust flow 235 traversing from the first segment 190 thus creating a mixed flow.

A third segment 240 is provided and is oriented aft of the second segment 195 to also form an ejector 250. Airflow, as represented by the arrow designated by reference numeral 245, enters the bottom of the ejector 250, but may also enter around the entire circumferential periphery of the s-shaped conduit 180. In other forms, the airflow 245 may enter at the top or sides of the ejector 250, or be divided into two or more streams. The airflow 245 entering the ejector 250 is entrained in the mixed flow traversing from the second segment 195.

The relative orientation of the first segment 190, the second segment 195, and the third segment 240 creates an s-shaped pathway 255 that includes two reversals of curvatures denoted by the inflection points 260 and 265. It will be understood that the first segment 190, the second segment 195, and the third segment 240 may be arranged to provide any number of inflection points, including only one as would be defined by a literal s-shaped. In this way, the term “s-shaped” includes a sinuous shape of a conduit that has at least one inflection point, and also includes a sinuous shape that has more than one inflection point such that it defines more than a single s-shaped portion. It will also be understood that either or both ejectors may be located upstream or downstream of an inflection point as suits a particular application.

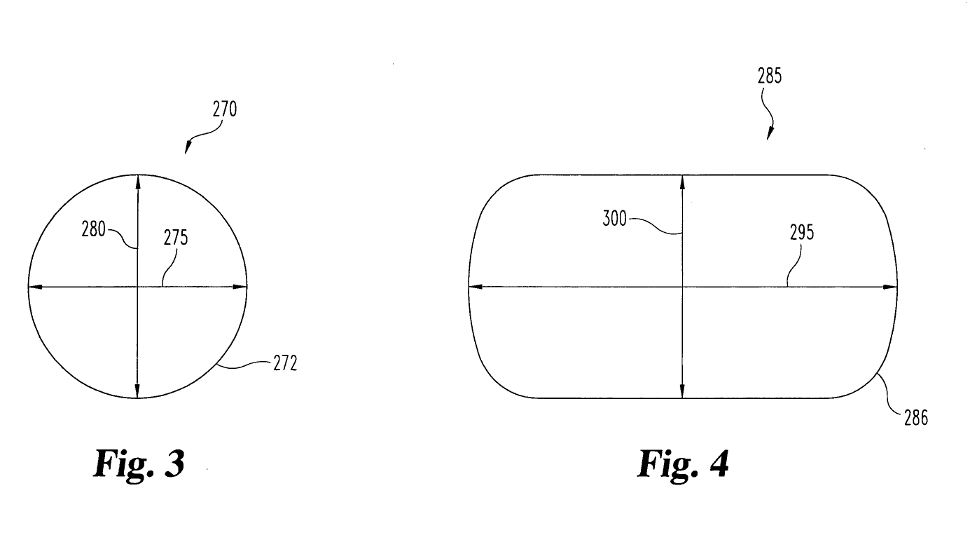

FIGS. 3 and 4 depict cross-sectional views taken of the s-shaped conduit 180 illustrated in FIG. 2 taken along view lines 3-3 and 4-4, respectively. FIG. 3 shows a projected exhaust inlet 270 having a substantially circular shape 272, but other shapes are also contemplated. The projected exhaust inlet 270 has a projected exhaust inlet width 275 and a projected exhaust inlet height 280, both of which may be transverse to the flow path through an s-shaped conduit 180. The ratio of the projected exhaust inlet width 275 to the projected exhaust inlet height 280 may be referred to as inlet aspect ratio of projected exhaust inlet 270. Inlet aspect ratio is approximately 1:1 (approximately unity), but may have other values in other implementations.

FIG. 4 shows a projected outlet 285 having a rounded rectangular shape 286, but other shapes are also contemplated. Similar to the projected exhaust inlet 270 discussed above, the projected exhaust outlet 285 has a projected outlet width 290 and a projected outlet height 300. The ratio of the projected outlet width 290 to the projected outlet height 300 may be referred to as outlet aspect ratio of the projected exhaust outlet 285. In one form, the inlet aspect ratio and the outlet aspect ratio differ, preferably the outlet aspect ratio is greater than the inlet aspect ratio, and more preferably the outlet aspect ratio is greater than the inlet aspect ratio and is greater than unity.

The s-shaped conduit 180 may vary smoothly between the shapes of the projected exhaust inlet 270 and the projected exhaust outlet 285, or may be discontinuous at some point along the length of the duct. For example, the cross section of the s-shaped duct 180 may be held substantially circular for the length of the first segment 190 and then abruptly change to a different cross sectional shape for the length of the second segment 195. In another form, the cross section may change along one segment but be held substantially constant across another. In yet another form the cross section of both segments may be substantially the same.

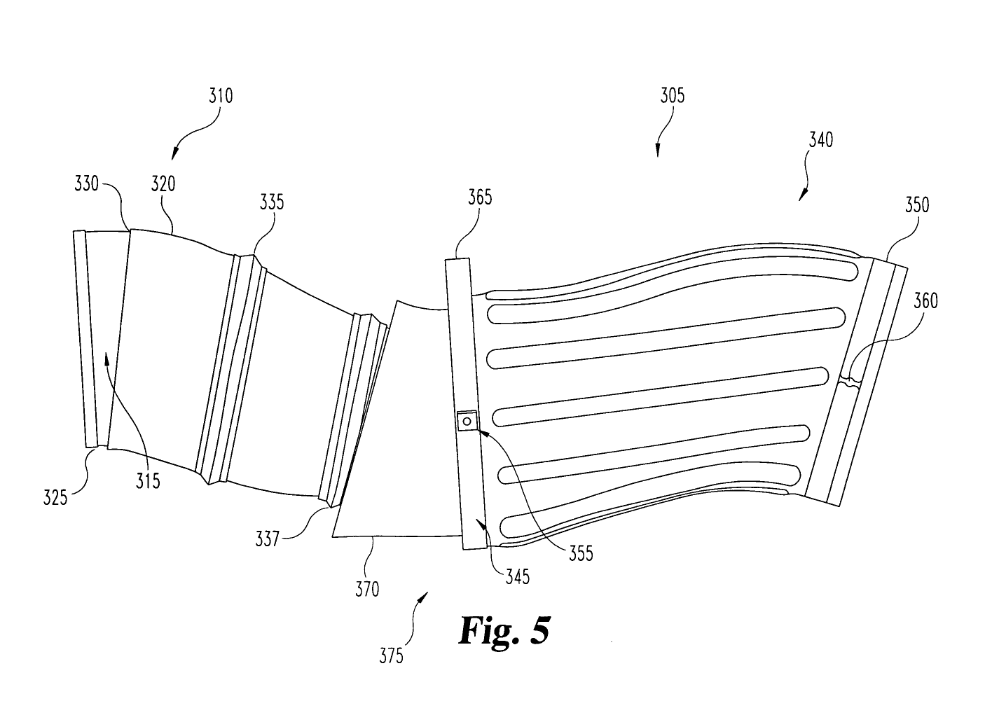

Referring to FIG. 5, another form of an ejector-assisted suppression device is illustrated in the form of s-shaped conduit 305; where like reference numerals refer to like features. Conduit 305 is structured for attachment to an outlet of a gas turbine engine (not shown) in place of one of the embodiments previously described and comprises two segments. A first segment 310 is composed of a forward section 315 and an aft section 320 that are coupled together. The forward section 315 can be attached to an existing turbine frame section of a gas turbine engine by a primary mount flange 325. Though the first segment 310 is comprised of two sections in FIG. 5, it will be understood that more or fewer sections may be included in the first segment 310. Furthermore, the sections in other forms may be capable of receiving each other axially, radially, or in any other configuration. A cooling slot 330 is formed between the forward section 315 and the aft section 320 and serves to provide cooling air for the s-shaped conduit 305. The cooling slot 330 is z-shaped in the illustrative embodiment and also serves to maintain the spacing between the forward section 315 and second section 320. The cooling slot 330 may be configured to permit cooling air to enter the entire periphery of the s-shaped conduit 305 or may be configured to limit cooling air exposure/entry to a certain region or regions. Also included are stiffening bands 335 and 337 used on the aft section 320 of the first segment 310 to provide structural support.

A second segment 340 is located aft of the first segment 310 and includes support channels 345 and 350 and mount bosses 355 and 360. The second segment 340 also includes a forward flow blocker 365 that extends in the space defined between the s-shaped conduit 305, the nacelle 100, and a bottom surface 367 of the wing 65. The forward flow blocker 365 impedes airflow from flowing in the nacelle 100 from one side of the forward flow blocker 365 to the other side. The forward flow blocker 365 substantially surrounds the s-shaped conduit 305 in the illustrative embodiment, but in other embodiments may only partially surround the conduit s-shaped conduit 305. A heat shield 370 is located between the first segment 310 and the second segment 340 to provide for thermal management of the s-shaped conduit 305. An ejector 375 is formed by the relative orientation of the second segment 340 and the heat shield 370. In addition, an ejector 377 is also formed between the first segment 310 and heat shield 370. Both ejectors 375 and 377 operate in the same manner as the previously described ejectors.

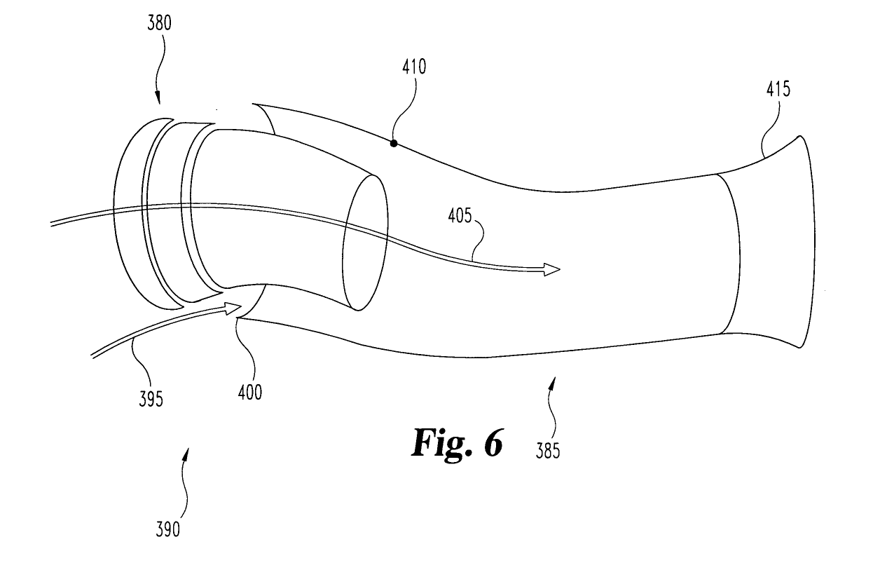

FIG. 6 represents yet another embodiment of a multisegment s-shaped conduit of a suppression device. It includes a first segment 380 capable of being permanently or releasably attached to the outlet of a gas turbine engine (not shown), and a second segment 385 structured to receive at least a part of the first segment 380. The relative orientation of the segments 380 and 385 forms an ejector 390 that operates like the various forms of ejectors described previously. Airflow, as indicated by an arrow designated by reference numeral 395, enters an ejector inlet 400 and is thereafter entrained in an exhaust flow 405 as designated by the like labeled arrow. An inflection point 410 is formed downstream of the inlet 400. An outlet 415 of the second segment 385 is flared, and in other embodiments may comprise any number of shapes such as circular or rectangular.

Many different embodiments are envisioned, for example in some embodiments the nacelle and second segment may be formed as an integrated suppression apparatus. In still other implementations, the nacelle second segment, and first segment may be formed in an integrated assembly that may be capable of attachment directly to the wing. Additionally and/or alternatively, an integrated assembly may be mounted to the exhaust outlet of gas turbine engine.

In one particular form, a suppression device is provided to that can be retrofit to the engines of pre-existing aircraft. This form may include a nacelle that carries a multisegment s-shaped conduit that can be connected to the pre-existing exhaust outlet of an engine. One implementation of such form is used to retrofit underwing turboprop engines, such as those of a C-130 fixed wing aircraft.

In another embodiment, an ejector formed by a third segment and second segment can have a configuration independent of the configuration of an ejector formed by a first segment and second segment. For example, a bifurcated stream may be configured to enter a first ejector and a peripheral stream may enter a second ejector.

Still another embodiment of the present application includes a nozzle system having an s-shaped duct. Two segments comprise the s-shaped duct wherein a margin of one segment is at least partially nested in the margin of another segment. The relative orientation of the two segments defines an ejector configured to mix a secondary flow stream with a primary flow stream.

In still another embodiment, a fixed wing aircraft powered by a gas turbine engine includes an s-shaped duct to receive and discharge an exhaust flow. An ejector is formed along the length of the s-shaped duct to mix air with the exhaust flow before being discharged through the outlet.

In yet another embodiment, an s-shaped duct is provided having an inlet with a first aspect ratio and an outlet with a second aspect ratio. The first aspect ratio is taken from a cross section of the duct near the inlet end and the second aspect ratio is taken from a cross section of the duct near the outlet. Both aspect ratios are determined by dividing a maximum distance by a minimum distance of the cross section. The cross sections may be transverse to a flow from a gas turbine engine. The first cross section may be circular in shape thus having a near unity aspect ratio while the outlet aspect ratio may be rectangular in shape, thus resulting in a greater than unity aspect ratio.

Another embodiment includes: providing a gas turbine powered aircraft having a turbine exhaust, connecting a first duct segment to the turbine exhaust, and installing a nacelle having a second duct segment such that the relative orientation of the first duct segment and the second duct segment create an s-shaped conduit having an ejector with an ejector lip.

In a further embodiment, the present invention provides means for ducting an exhaust flow in an s-shape and providing an ejector therein. The ducting is comprised of two segments wherein one segment nestingly receives another segment. An ejector means is formed by the relative orientation of the first segment to the second segment wherein a secondary flow stream is entrained in a primary flow stream. The relative orientation of the two segments provides at least one inflection point.

In a still further embodiment, means for ducting the exhaust from a gas turbine powered aircraft are provided, including an s-shaped means and an ejector means. The ejector means is capable of mixing air with an exhaust flow from the gas turbine engine.

In a still another embodiment, means for ducting the exhaust from a gas turbine powered aircraft are provided, including an s-shaped means and an ejector means. The s-shaped means having an inlet aspect ratio less than an outlet aspect ratio.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An apparatus, comprising:
a first gas turbine exhaust duct segment defining an exhaust inlet to receive exhaust from an engine turbine and a first segment margin defining a first segment opening to discharge the exhaust from the first segment;
a second gas turbine exhaust duct segment including a second segment margin defining a second segment opening to receive the exhaust from the first segment opening and an outlet to discharge the exhaust from the second segment, the first segment margin being at least partially nested within the second segment margin to define an ejector having an ejector inlet formed by the relative orientation of the first segment margin and the second segment margin; and
an s-shaped conduit at least partially defined by the first segment and the second segment and defining an s-shaped discharge pathway having a reversal of curvature between the ejector and the outlet.

2. The apparatus of claim 1, further comprising a third turbine exhaust duct segment coupled to the outlet.

3. The apparatus of claim 1 further comprising another ejector formed in the s-shaped conduit at a location downstream of the ejector.

4. The apparatus of claim 1, further comprising a fixed wing aircraft carrying a gas turbine engine of a turboprop type, the gas turbine engine being connected to the first segment.

5. The apparatus of claim 1, wherein the s-shaped conduit includes a cooling slot.

6. The apparatus of claim 1, wherein the exhaust inlet is approximately circular and the exhaust outlet is approximately rectangular.

7. The apparatus of claim 1, further comprising a nacelle at least partially enclosing the s-shaped conduit, the nacelle configured to be in fluid communication with the ejector.

8. The apparatus of claim 1, wherein the first segment includes at least one stiffening band.

9. The apparatus of claim 1, wherein the first segment includes a flow blocker.

10. The apparatus of claim 1, further comprising a heat shield disposed between the first segment and the second segment.

11. An apparatus, comprising:
a fixed wing aircraft including a turboprop engine;
an s-shaped exhaust duct including an exhaust inlet to receive exhaust from the turboprop engine and an outlet to discharge the exhaust; and
an ejector formed along the s-shaped conduit, the ejector having a lip defining an ejector inlet to mix air with the exhaust before being discharged through the outlet.

12. The apparatus of claim 11, further comprising another ejector formed in the s-shaped exhaust duct downstream of the ejector.

13. The apparatus of claim 11, wherein the s-shaped conduit includes a cooling slot.

14. The apparatus of claim 11, wherein the exhaust inlet has a projected exhaust inlet and the exhaust outlet has a projected exhaust outlet, the projected exhaust inlet includes a maximum inlet dimension and a minimum inlet dimension to define a maximum to minimum exhaust inlet aspect ratio, and the projected outlet including a maximum outlet dimension and a minimum outlet dimension to define a maximum to minimum outlet aspect ratio, the exhaust inlet aspect ratio being less than the outlet aspect ratio.

15. The apparatus of claim 11, wherein the exhaust inlet is approximately circular and the exhaust outlet is approximately rectangular.

16. The apparatus of claim 11, further comprising a nacelle at least partially enclosing the s-shaped conduit, the nacelle configured to be in fluid communication with the ejector.

17. The apparatus of claim 11, wherein the ejector is located on the upstream side of an inflection point in the s-shaped conduit.

18. An apparatus, comprising:
an s-shaped exhaust conduit for a gas turbine engine, the s-shaped exhaust conduit defining an s-shaped flow path from an inlet to an outlet, the inlet including a maximum inlet dimension transverse to the flow path and a minimum inlet dimension transverse to the flow path to define a maximum to minimum inlet aspect ratio and the outlet including a maximum outlet dimension transverse to the flow path and a minimum outlet dimension transverse the flow path to define a maximum to minimum outlet aspect ratio, the inlet aspect ratio being less than the outlet aspect ratio; and
an ejector formed in the s-shaped conduit between the inlet and the outlet, the ejector having a lip leading edge that is non-planar.

19. The apparatus of claim 18, further comprising a second ejector formed in the s-shaped exhaust conduit downstream of the ejector.

20. The apparatus of claim 18 wherein the s-shaped exhaust conduit includes a cooling slot.

21. The apparatus of claim 18, wherein the inlet is approximately circular and the outlet is approximately rectangular.

22. The apparatus of claim 18 further comprising a fixed wing aircraft carrying a gas turbine engine of a turboprop type, the gas turbine engine being connected to the s-shaped conduit.

23. The apparatus of claim 18, further comprising a nacelle at least partially enclosing the s-shaped conduit, the nacelle configured to be in fluid communication with the ejector.

24. The apparatus of claim 21, wherein the ejector is located on the inlet side of an inflection point in the s-shaped conduit.

25. A method, comprising:
providing a gas turbine powered aircraft having a turbine exhaust;
connecting a first duct segment to the turbine exhaust; and
installing a nacelle onto the gas turbine powered aircraft, the nacelle including a nacelle inlet and a second duct segment wherein the relative orientation of the first duct segment and the second duct segment creates an s-shaped conduit having an ejector with an ejector lip, the ejector lip formed by the relative orientation of the first duct segment to the second duct segment.

26. The method of claim 25, further comprising operating the gas turbine powered aircraft, which includes providing air flow from the propeller to the s-shaped conduit through the ejector and mixing the air flow with exhaust flow from the turbine exhaust.

27. The method of claim 25 further comprising orienting a third duct segment relative to the second duct segment wherein a further ejector is formed by the relative orientation of the second duct segment to the third duct segment.

28. The method of claim 25, wherein installing the nacelle further comprises providing the nacelle inlet in fluid communication with the ejector.

29. The method of claim 25, wherein the ejector is located upstream of a reversal in curvature of the s-shaped conduit and the s-shaped conduit changes shape from approximately circular at one end to approximately rectangular at the other end.

30. The method of claim 25, which includes:
flying the aircraft before the connecting of the first duct segment and the installing of the nacelle;
selecting the aircraft for an retrofit of a suppression device thereto; and
performing the connecting of the first duct segment and the installing of the nacelle to provide the retrofit of the suppression device.
